(19) United States
(12) Patent Application Publication
(10) Pub. No.: US 2009/0066948 A1
(43) Pub. Date: Mar. 12, 2009

(54) Compact Terahertz Spectrometer Using Optical Beam Recycling and Heterodyne Detection

(75) Inventors: Nicholas Karpowicz, Schenectady, NY (US); Xi-Cheng Zhang, Melrose, NY (US); Keith H. Johnson, Cambridge, MA (US); Matthew Price-Gallagher, Westmount (CA)

Correspondence Address: CHOATE, HALL & STEWART LLP, TWO INTERNATIONAL PLACE, BOSTON, MA, 02110, US

(73) Assignee: HYDROELECTRON VENTURES, INC., Westmount (CA)

(21) Appl. No.: 11/851,476

(22) Filed: Sep. 7, 2007

(51) Int. Cl. G01J 3/28

(52) U.S. Cl. 356/326

(57) ABSTRACT

Compact terahertz spectrometer. The spectrometer includes an optical beam both for generating terahertz radiation for interaction with the sample and for use in a detector. A DC heterodyne detector uses a DC field-induced second harmonic wave at a sensor plasma to serve as a local oscillator. The spectrometer has a bandwidth orders of magnitude larger than conventional THz spectrometers.

### BACKGROUND OF THE INVENTION

The present invention relates to a broadband terahertz spectrometer and more particularly to a compact terahertz spectrometer utilizing optical beam recycling and heterodyne detection of femtosecond laser pulses.

Terahertz (THz) radiation offers innovative sensing and imaging technologies that can provide structural and spectroscopic information unavailable through conventional methods. With the advancement of THz technologies, THz sensing and imaging will impact a broad range of interdisciplinary fields including chemical, biological, explosives and related compounds (ERCs) detection and identification.

THz radiation can penetrate through many non-polar dielectric materials so that it can be used for non-destructive/non-invasive sensing and imaging of targets under covers or in containers. An immediate application of THz wave technology is non-destructive testing. Other short term and long term applications include spectroscopic sensing and imaging for homeland security and for biomedical applications.

Transmitted or reflected THz spectra of sample materials contain THz fingerprints that provide rich information about the sample material unavailable in other portions of the electromagnetic spectrum. As an example, FIGS. 1A-1L show the absorption spectra from twelve solids samples: four commonly used explosives (RDX, TNT, HMX, and PETN), four chemical and four biological samples. These spectra were taken in dry nitrogen gas. The marked phonon peaks in the spectra are the unique signatures. Note that the absorption spectra in FIG. 1 covered the spectral range from 0.1 to just under 3 THz. The unique absorption features allow the target or sample to be easily distinguished from background. However, what is missing is the absorption spectrum greater than 3 THz. For sample identification and classification it is highly important that more spectroscopic information beyond 3 THz be acquired. More spectroscopic information will reduce a false alarm rate.

Current commercial approaches to THz sensing and imaging have several limitations that restrict their real-world application. Two of the most significant limitations are the limited THz output power of conventional sources, and phonon-resonances of emitter and detector materials (such as GaAs and ZnTe) that limit the spectral range of the instruments typically from 0.1 to 3 THz, about ⅓ of the THz wave frequency range (0.1 THz to 10 THz).

It is an object of the present invention to unlock the full potential of the terahertz band by providing a terahertz spectrometer having more than one order of magnitude of frequency bandwidth and two orders of magnitude dynamic range improvement over known broadband THz spectrometers. Another one to two orders of magnitude increase is feasible.

Another object of the invention is a THz spectrometer that we have demonstrated that saves approximately half of the optical energy that is crucial for any non-linear THz spectroscopy.

Yet a further object of the invention is a compact THz spectrometer that we have demonstrated that covers the range of 0.1 up to 20 THz without changing beam splitters and detectors used in the spectrometer.

### SUMMARY OF THE INVENTION

In one aspect, the invention is a compact THz spectrometer including an optical beam both for generating terahertz radiation for interaction with a sample and for use in a detector. A heterodyne method is provided that uses a low duty cycle rate electric bias field-induced second harmonic wave at a sensor plasma as a local oscillator.

In another aspect, the compact THz spectrometer disclosed herein includes recycling an optical beam. A femtosecond laser pulse is first used in a nonlinear optical crystal to generate a 400 nm beam and then the 800 nm and 400 nm beams are focused on the same spot in the air to generate THz radiation through four-wave optical mixing. After the THz wave generation the remaining fundamental optical beam (800 nm) is focused on the air at the same location where the THz radiation is focused. At this focus, a pair of bias electrodes applies a low frequency bias. Filter means is provided for eliminating the 800 nm beam and passing the 400 nm beam into a detector.

In a preferred embodiment of this aspect of the invention, the first optical means includes a BBO crystal for generating the 400 nm beam. The first optical means also includes a quarter-wave plate to generate the 800 nm beam from the laser pulse. It is preferred that the third optical means includes means for changing beam path length.

In yet another aspect, the compact terahertz spectrometer according to the invention includes a femtosecond laser to generate a pulse and a quarter-wave plate for generating an 800 nm beam from the pulse. A lens focuses the beam and a crystal receives the 800 nm beam and generates a 400 nm beam along with the 800 nm beam. Ambient air is located at the focus point of the 800 nm and 400 nm beams to create a plasma that generates THz radiation. The focus point of the beams is also located at the focus point of a first parabolic mirror that receives the beams and the THz radiation and makes them parallel. A first ITO glass reflects the THz beam and transmits the laser beams. A second parabolic mirror receives and focuses the THz beam for transmission through a sample target at a focus point. A third parabolic mirror receives the THz radiation transmitted through the sample and makes it parallel. A fourth parabolic mirror receives the parallel THz radiation and focuses it and a second ITO glass directs the THz beam to focus at the center of DC bias electrodes having air therebetween.

A first optical means receives the laser beams transmitted through the first ITO glass and adjusts the optical path length. A filter removes the 400 nm beam and passes the 800 nm beam. Second optical means focuses this 800 nm beam on ambient air between the DC bias electrodes to generate a plasma that generates a 400 nm beam (second harmonic of the fundamental beam at 800 nm). A filter receives the beam from the focus point between the DC bias electrodes and eliminates the 800 nm beam. A detector receives the 400 nm beam to provide a spectrum.

The THz air-breakdown-coherent-detection (THz-ABCD) spectrometer disclosed herein has a decreased size and significantly enhanced sensitivity of THz wave detection.

### BRIEF DESCRIPTION OF THE DRAWING

FIGS. 1A-L are graphs of absorption coefficient vs. frequency for target materials subjected to terahertz radiation.

FIG. 2A is a graph of integrated THz amplitude vs. bias field resulting from an experiment.

FIG. 2B is a graph of integrated THz amplitude vs. probe pulse energy experimentally measured.

FIG. 3A is a graph of amplitude vs. time delay with high THz field.

FIG. 3B is a graph of amplitude vs. frequency showing the widest spectrum.

FIG. 4A is a graph of attenuation vs. frequency of water vapor up to 12 THz.

FIG. 4B is an absorption spectrum of black powder.

FIGS. 5a and 5b are schematic illustrations of an embodiment of the compact THz spectrometer disclosed herein.

FIG. 6 is a graph of amplitude vs. frequency demonstrating a greater than 20 THz range.

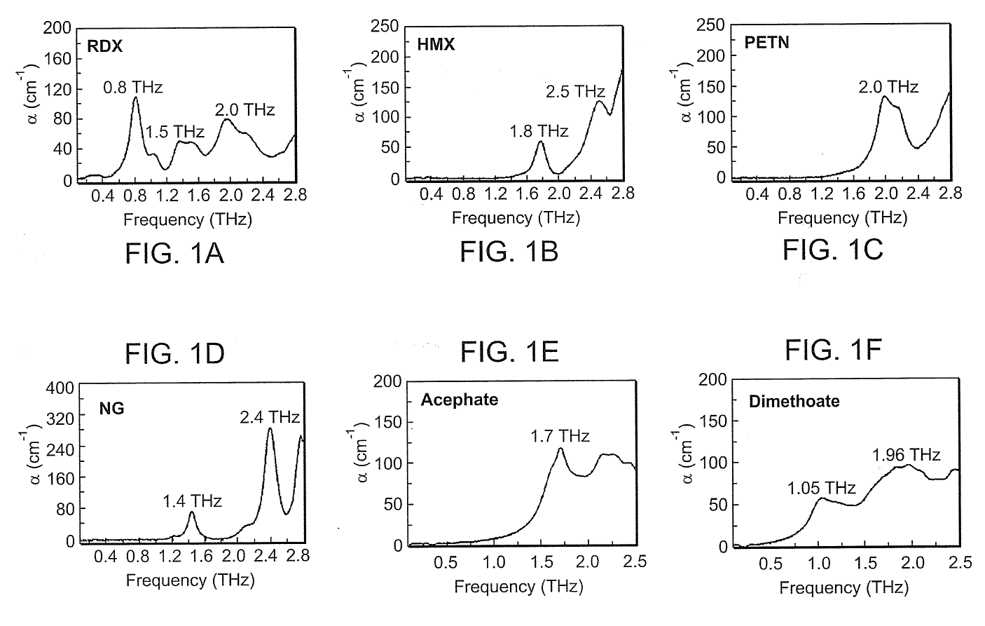

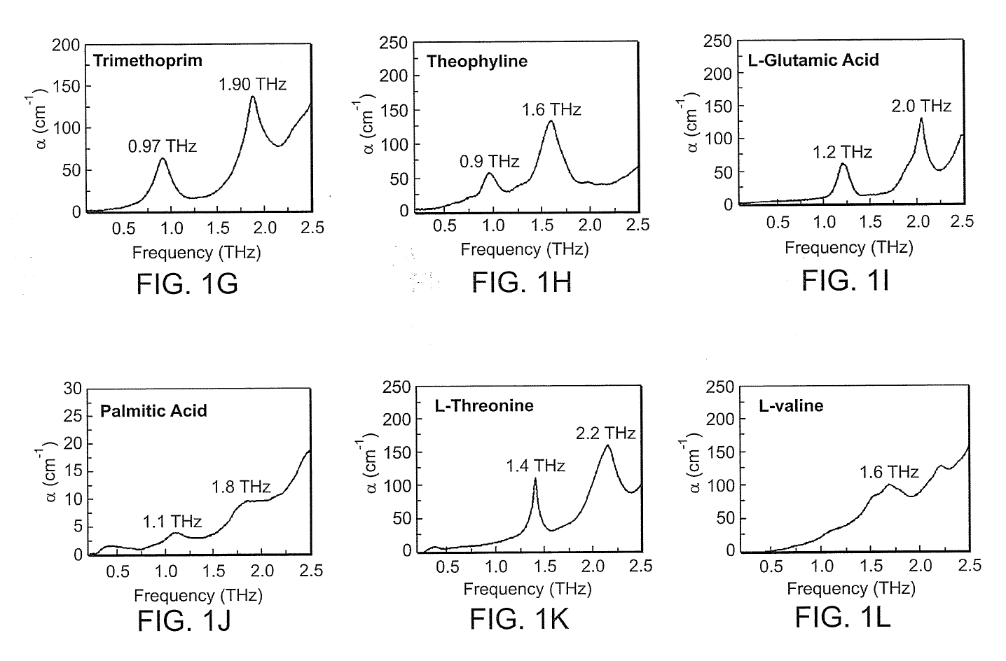

### DESCRIPTION OF THE PREFERRED EMBODIMENT

Perhaps the greatest advantage for using air as a THz wave sensor is the flexibility of selecting sensing location, since air is everywhere. Similar to the generation of THz waves in the air by third-order nonlinear susceptibility, we also propose to detect the THz waves in air with a third-order nonlinear optical process. There are several possible configurations for the third-order nonlinear optical process, but initially we will focus on the following two experimental configurations: (1) Detection of the rotation of the probe pulse by THz waves, and (2) Detection of second-harmonics generated through the nonlinear interaction of the air, THz waves and the probe pulse. The former requires two optical probe pulses: one at the fundamental frequency and the other at the second-harmonic frequency. The measurement of the rotation of polarization is widely used as a sensitive detection technique particularly in THz detection using electro-optic crystals such as ZnTe or GaP. The latter configuration detects the signal at different frequencies from the probe pulses, which makes it possible to detect very weak signals in the presence of a strong background. THz detection using the latter configuration has been reported in liquids and solids, called THz-field-induced-second-harmonic, but not in gasses.

The general physical concept of THz-field-induced-second-harmonic can be understood in a third-order nonlinearity process, similar to the generation of the THz wave in the air. It can be written as below:

E_{2ω}(t)∝χₓₓₓₓ⁽³⁾E_{THz}(t−τ)E_{ω}(t)E_{ω}(t)=χₓₓₓₓ⁽³⁾E_{THz}(t−τ)I_{ω}(t) (1)

Two fundamental photons plus one THz photon create a second-harmonic photon. All of the polarizations are in the same direction. Since the E_{2ω}(t)∝E_{THz}(t−τ)E_{ω}(t)E_{ω}(t), it follows that the intensity of the measured second-harmonic signal is proportional to the intensity of the THz wave: I_{2ω}(t)∝I_{THz}(t−τ) with the air sensor, the measurement predicted in Eqn. (1) which is incoherent. Therefore, the phase information is lost.

One of the most valuable properties of this THz time-domain spectroscopy is coherent detection. If the air sensor detection is incoherent (lack of phase information) then its application will be very limited. However, with the introduction of DC-field-induced second harmonic generation as a local oscillator, a perfect coherent detection is achieved.

When we include the second-harmonic local oscillator contribution E^{LO}_{2ω} into the analysis (high power laser pulse on a quartz lens or plasma white light with an effective susceptibility χ), the total second-harmonic intensity in the time average values over one period of E-field oscillation has the form:

I_{2ω}∝(E_{2ω})²=(E^{signal}_{2ω}+E^{LO}_{2ω})²=(E^{signal}_{2ω})²+(E^{LO}_{2ω})²+2E^{signal}_{2ω}E^{LO}_{2ω}cos(φ) (3)

where φ is phase difference between the E^{signal}_{2ω} and E^{LO}_{2ω}, and

E^{signal}_{2ω}∝χ⁽³⁾E_{ω}E_{ω}E_{THz}=χ⁽³⁾I_{ω}E_{THz} (4)

E^{LO}_{2ω}∝χ⁽³⁾E_{ω}E_{ω}E_{DC}=χ⁽³⁾I_{ω}E_{DC}, (5)

where χ⁽³⁾ is the third-order susceptibility of air, and E_{DC} is the DC electric field applied on the sensor plasma. Therefore Eqn. (5) can be written as:

I_{2ω}∝(χ⁽³⁾I_{ω})²[(E_{THz})²+2E_{DC}E_{THz}+(E_{DC})²]. (6)

The first term in the bracket is proportional to the intensity of the THz wave. The second term is the interference term. The third term is the DC-field-induced second harmonic signal. With the use of a lock-in amplifier at the modulation frequency on the DC bias field, the first and third terms are averaged to zero. Since both THz-field- and DC-field-induced second harmonic generations are from the same plasma spot, phase is perfectly matched, therefore in Eqn. (3) phase difference φ=0, and cos(φ)=1.

Eqn. (6) obtained by a plane-wave approximation implies that the intensity of the second-harmonic signal in the cross term has the form

I_{2ω}(τ)∝2[χ⁽³⁾I_{ω}(t−τ)]²E_{DC}E_{THz}(t). (7)

Eqn. (7) shows that I_{2ω} is proportional to I_{ω}² and E_{DC}. An experimental measurement was in good agreement with this equation. The intensity of the 2ω signal measured by a photon multiplier tube or an UV avalanche diode is linearly proportional to the THz field.

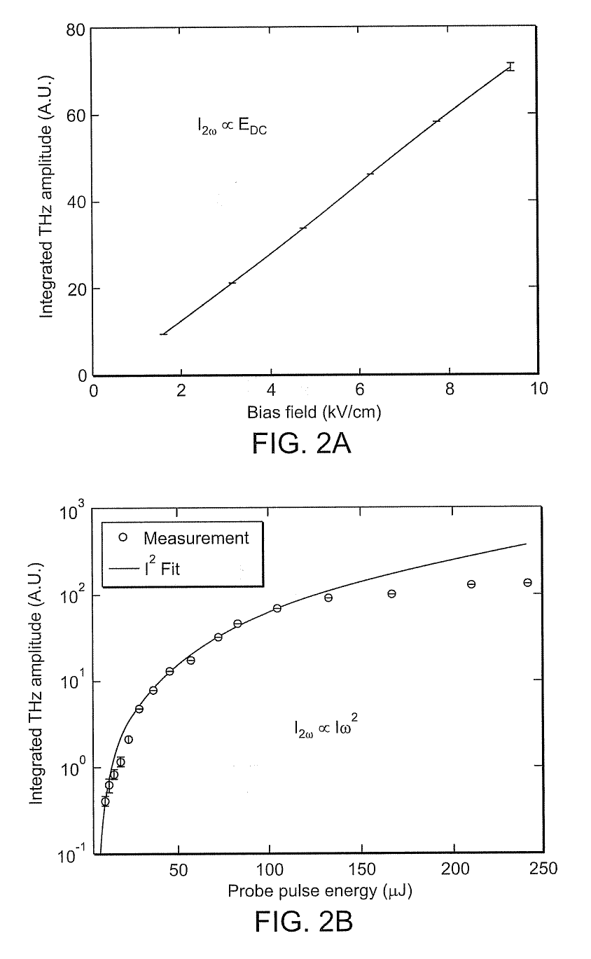

FIG. 2 plots our preliminary experimental measurement of I_{2ω}∝V_{DC} and I_{2ω}∝I_{ω}², respectively. E_{DC}=V_{DC}/gap, and an excellent linearity agreement of I_{2ω}∝E_{DC} is achieved in FIG. 2a. Eqn. (7) predicts a quadratic relationship (I_{2ω}∝I_{ω}²) as long as the probe beam is not largely depleted after the air plasma is generated (threshold is approximately at 100 μJ), as shown in FIG. 2b. Theoretical predication and experimental measurement agree well.

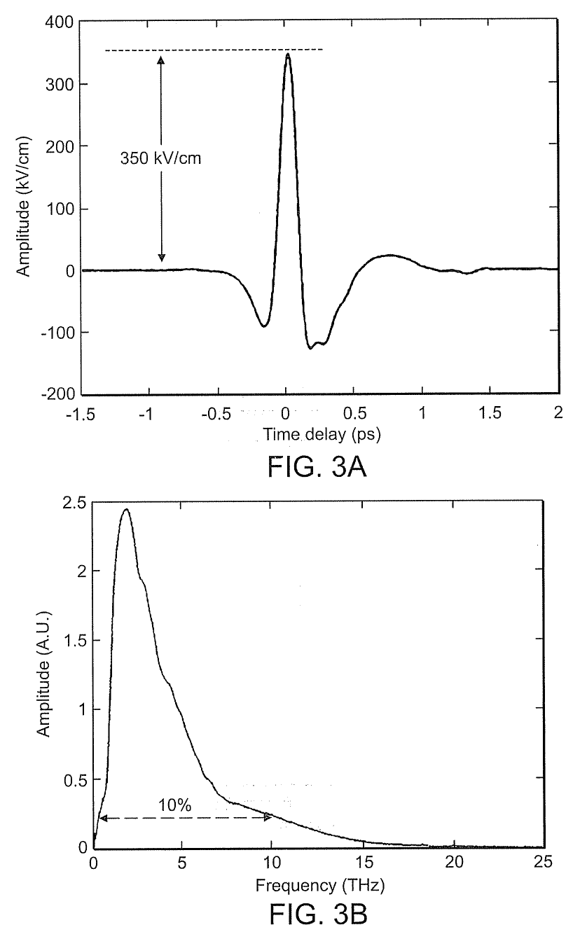

FIG. 3 plots a typical THz waveform with high THz field (350 kV/cm) and a linear plot of the widest spectrum (10% bandwidth: <0.1 THz to >10 THz, tail reaches 20 THz). The common dielectric breakdown field strength is about 3 MV/m or 30 kV/cm. Our field strength generated on a table top system is already 10 times stronger than the air dielectric breakdown threshold. We have observed air breakdown (sparks) when the sub-picosecond THz field is applied to the laser sensing plasma.

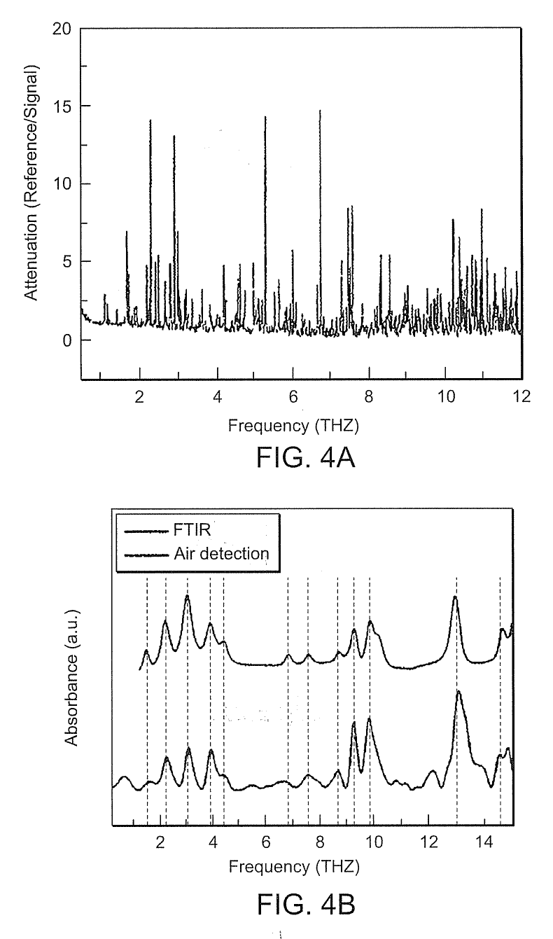

We used a laser with an 80 fs pulse duration to perform THz ABCD spectroscopic measurement on several selected targets. FIGS. 4a and 4b plot the water lines up to 12 THz, and the explosive material black powder up to 15 THz, respectively. For comparison, FIG. 4b also plots the measurements by using a Bruker FTIR system (top curve) and by a prototype THz ABCD system (bottom curve). We found that the signal-to-noise ratio (SNR) in this THz ABCD system is proportional to the strength of the local oscillator E_{DC}, as predicated in Eqn. (7).

There are two major differences with the geometry of an embodiment of the invention compared with previous reported techniques of detecting terahertz waves using gasses. First the fundamental optical beam is recycled. The optical beam creates first plasma to emit the THz wave, then the remaining optical beam is separated from the THz wave and used to create secondary plasma to detect the THz wave. The full optical energy is used for both THZ wave generation and detection for increasing the THz electric field strength and improving detection sensitivity. Second is the heterodyne capability. By applying an AC bias on the second plasma, the bias-field-induced second harmonic signal serves as the local oscillator in heterodyne detection.

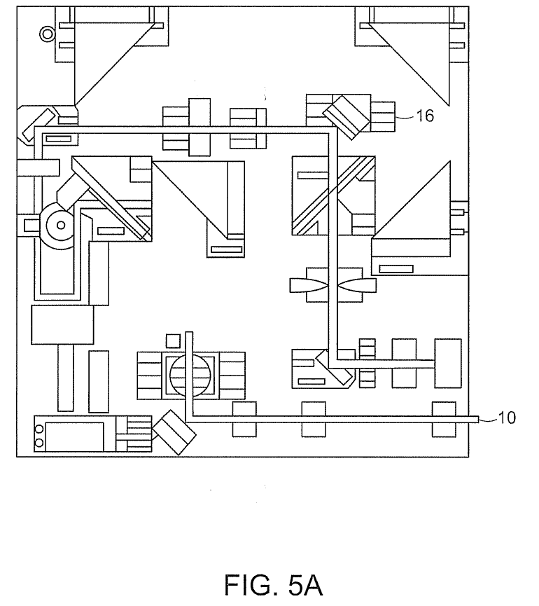

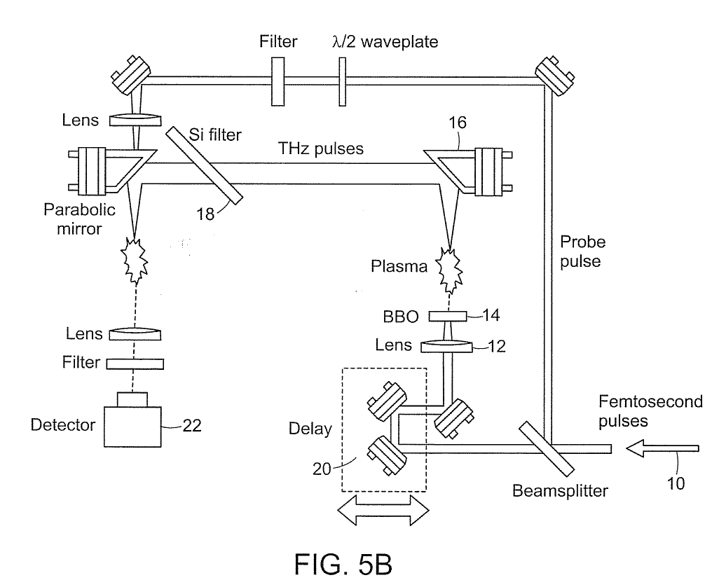

With reference now to FIGS. 5a and 5b, an input laser pulse from a Ti:Sapphire amplified laser amplifier 10 (Spectra-Physics Hurricane), with a repetition rate of 1 kHz, pulse energy of 600 μJ, duration of 80 fs and central wavelength of 800 nm, was focused using a 125 mm focal length lens 12. A 100 μm thick type-II BBO crystal 14 generated a second harmonic pulse between the lens and the focal spot. The fundamental and second harmonic pulses mix at the focus, producing a THz pulse through third-order optical rectification. All of the radiation was then collimated by a 90° off-axis parabolic mirror 16. The collimated beam was then incident onto a sheet of glass coated with indium tin oxide (ITO), which reflects the THz wave but is transparent to the optical beams. The THz wave, passing through a silicon wafer 18 to block the residual optical reflection from the ITO glass, was then focused, collimated and refocused by three additional parabolic mirrors.

The optical beam that passes through the ITO glass was sent through a time delay stage 20 and low-pass filter to control the timing and eliminate the second harmonic wave. It was focused by another 125 mm lens through a hole on the final parabolic mirror in the THz beam path. The THz and optical beams were then focused collinearly to the same spot where the THz field induced a new second-harmonic pulse. A pair of electrodes were placed across this spot with an applied ˜3 kV, 500 Hz AC bias (synchronized with the laser repetition rate). The second harmonic beam was then filtered by a pair of 400 nm band-pass filters and sent into a photomultiplier tube (PMT) 22. The signal from the PMT was measured by a lock-in amplifier referenced to the 500 Hz bias modulation frequency. The polarizations of all the fields (THz, fundamental, second harmonic, and AC bias) are in the same direction.

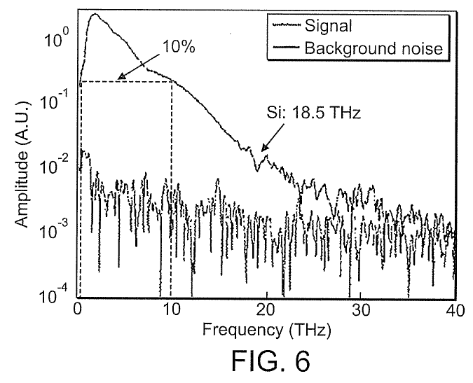

Since the generation and detection of the THz wave uses air, the spectrum of the THz time-domain spectrometer is only limited by the inverse of the pulse duration of the laser used. FIG. 6 plots the measured spectrum using dry nitrogen as a THz wave emitter and sensor. Unlike the case of electro-optic sampling in a crystal such as ZnTe or GaP, there are no phonon modes to introduce dispersion or absorption into the detection region; as well as there are no optical or THz reflections from the solid emitter and sensor materials. As a result, the detected spectrum can be continuous and cover the full bandwidth of the input laser pulse. With 80 fs laser pulses, the spectrum covers the region from 0.3 to 10 THz with 10% or greater of the maximum amplitude in dry nitrogen gas, and meets the noise floor of the measurement at approximately 20 THz. Due to the use of a silicon filter in the THz beam path to remove the residual optical beam, the higher frequency end spectrum should show silicon intrinsic properties. As expected, several features (dips in the spectrum) near the 18.5 THz are due to the silicon absorption.

In summary, we have disclosed and demonstrated recycling an optical beam along with DC heterodyne detection to provide a compact THz air-breakdown-coherent-detection (THz-ABCD) spectrometer. The recycled optical beam and DC heterodyne detection greatly decreases the size of a THz ABCD spectrometer and significantly enhances the sensitivity of THz wave detection. The spectrometer disclosed herein provides bandwidth (using air-emitter and sensor) and sensitivity (heterodyne detection in a pulsed system) orders of magnitude greater than currently existing THz time-domain spectrometers.

It is recognized that modifications and variations of the invention disclosed herein will be apparent to those of ordinary skill in the art and it is intended that all such modifications and variations be included within the scope of the appended claims.

What is claimed is:

1. Compact THz spectrometer comprising:
an optical beam both for generating terahertz radiation for interaction with a sample and for use in a detector; and
a DC heterodyne detector using a DC field-induced second harmonic wave at a sensor plasma as a local oscillator.

2. Compact THz spectrometer comprising:
a femtosecond laser for generating a pulse;
first optical means for generating a fundamental beam and a second harmonic of the fundamental beam and focusing the beams on air to generate THz radiation;
second optical means for focusing the THz radiation on a sample and focusing the THz radiation transmitted through the sample on ambient air between DC bias electrodes;
third optical means for focusing the fundamental beam at the focus between the DC bias electrodes to generate a second harmonic of the fundamental; and
filter means for eliminating the fundamental beam and passing the second harmonic beam into a detector.

3. The spectrometer of claim 2 wherein the fundamental beam has an approximately 800 nm wavelength.

4. The spectrometer of claim 2 wherein the second harmonic of the fundamental has a wavelength of approximately 400 nm.

5. The spectrometer of claim 2 wherein the first optical means includes a BBO crystal for generating the second harmonic beam.

6. The spectrometer of claim 2 wherein the first optical means includes a quarter-wave plate to generate the fundamental beam from the laser pulse.

7. The spectrometer of claim 2 wherein the third optical means includes means for changing beam path length.

8. Compact terahertz spectrometer comprising:
a femtosecond laser to generate a pulse;
a quarter-wave plate for generating an 800 nm beam from the pulse;
a lens for focusing the beam;
a crystal for receiving the 800 nm beam and generating a 400 nm beam along with the 800 nm beam;
ambient air located at the focus point of the 800 nm and 400 nm beams to create a plasma that generates THz radiation, the focus point of the beams also being located at the focus point of a first parabolic mirror that receives the beams and THz radiation and makes them parallel;
a first ITO glass to reflect the THz beam and to transmit the laser beams;
a second parabolic mirror for receiving and focusing the THz beam for transmission through a sample at a focus point;
a third parabolic mirror for receiving the THz radiation transmitted through the sample and making it parallel;
a fourth parabolic mirror for receiving the parallel THz radiation and focusing it;
a second ITO glass for directing the THz beam to focus at the center of DC bias electrodes having ambient air therebetween;
first optical means for receiving the laser beams transmitted through the first ITO glass and for adjusting optical path length;
a filter for removing the 400 nm beam and passing the 800 nm beam;
second optical means for focusing this 800 nm beam on the ambient air between the DC bias electrodes to generate a plasma and to generate a 400 nm beam at the focus point between the DC bias electrodes;
a filter for receiving the beam from the focus point between the DC bias electrodes and eliminating the 800 nm beam; and
a detector for receiving the 400 nm beam.
